(19) United States
(12) Patent Application Publication
(10) Pub. No.: US 2015/0071402 A1
(43) Pub. Date: Mar. 12, 2015

(54) X-RAY IMAGING SYSTEM

(71) Applicant: CANON KABUSHIKI KAISHA, Tokyo (JP)

(72) Inventor: Soichiro Handa, Tokyo (JP)

(21) Appl. No.: 14/476,906

(22) Filed: Sep. 4, 2014

(30) Foreign Application Priority Data
Sep. 9, 2013 (JP) 2013-186216

(51) Int. Cl. G01N 23/20; G21K 1/06; G01N 23/207

(52) U.S. Cl. CPC G01N 23/20075; G01N 23/207; G21K 1/067
USPC 378/36; 378/71

(57) ABSTRACT

An X-ray imaging system includes: a micro X-ray source array formation part configured to form a micro X-ray source array by partially shielding an X-ray emitted from an X-ray source; and an X-ray detector configured to detect an X-ray transmitted through a test object. The micro X-ray source array formation part includes a plurality of gratings disposed between the X-ray source and the X-ray detector. A ratio of X-rays transmitted through all of the plurality of gratings to X-rays generated from the X-ray source varies depending on a position of an X-ray generating point on the X-ray source, and the micro X-ray source array formation part forms a micro X-ray source array of a pattern in accordance with the variation of the ratio of the transmitted X-rays.

### BACKGROUND OF THE INVENTION

1. Field of the Invention

The present invention relates to an X-ray imaging system.

2. Description of the Related Art

In a general X-ray imaging method, an image based on a transmittance distribution of a test object is obtained by irradiating the test object with an X-ray generated from an X-ray source and detecting the intensity distribution of the transmitted X-ray. In recent years, a method (phase imaging method) in which an image of a test object is taken by using information of a phase shift when an X-ray is transmitted through the test object has been researched and developed.

In a general X-ray imaging method, when a size of an X-ray source is too large, there are cases where sharpness of a test object image is reduced by an effect of so-called geometric unsharpness. In many phase imaging methods, there are similar problems. Furthermore, in some of the phase imaging methods, since a certain distance is required between the test object and an X-ray detector, there is a tendency that the effect of geometric unsharpness becomes large. The size of an X-ray source means a spatial expanse (a diameter, a length of one side, or an area) of a part in an X-ray generating device that generates an effective X-ray (X-ray generating part), and is also called a focus size.

The effect of geometric unsharpness may be suppressed by using an X-ray source of a smaller size. However, in general, the smaller the size of an X-ray source becomes, the higher the requirements for mechanical accuracy and stability of an X-ray generating device become, and the smaller the X-ray generating amount per unit time becomes. Therefore, there is a problem in that an attempt of making the size of an X-ray source smaller causes increase in device cost and increase in imaging time, which makes the device impractical.

### SUMMARY OF THE INVENTION

The present invention in its first aspect provides an X-ray imaging system comprising: a micro X-ray source array formation part configured to form a micro X-ray source array by partially shielding an X-ray emitted from an X-ray source; and an X-ray detector configured to detect an X-ray transmitted through a test object, wherein the micro X-ray source array formation part includes a plurality of gratings disposed between the X-ray source and the X-ray detector, a ratio of X-rays transmitted through all of the plurality of gratings to X-rays generated from the X-ray source varies depending on a position of an X-ray generating point on the X-ray source, and the micro X-ray source array formation part forms a micro X-ray source array of a pattern in accordance with the variation of the ratio of the transmitted X-rays.

The present invention in its second aspect provides an X-ray imaging system comprising: a micro X-ray source array formation part configured to form a micro X-ray source array by partially shielding an X-ray emitted from an X-ray source; and an X-ray detector configured to detect an X-ray transmitted through a test object, wherein the micro X-ray source array formation part includes a plurality of gratings disposed between the X-ray source and the X-ray detector, and is configured to form a micro X-ray source array of a pattern corresponding to moire generated by superposition of the plurality of gratings.

Further features of the present invention will become apparent from the following description of exemplary embodiments with reference to the attached drawings.

### BRIEF DESCRIPTION OF THE DRAWINGS

FIG. 1 is a view illustrating X-ray imaging systems of a first embodiment;

FIG. 2 is a view illustrating a manner in which a PSF is modulated by a first and a second gratings;

FIG. 3A to FIG. 3D are drawings illustrating a first and a second grating patterns and one example of a coded source;

FIG. 4A to FIG. 4D are drawings illustrating a first and a second grating patterns and one example of a coded source;

FIG. 5A to FIG. 5D are drawings illustrating a first and a second grating patterns and one example of a coded source;

FIG. 6A and FIG. 6B are views illustrating modified examples of the X-ray imaging system of the first embodiment; and

FIG. 7A and FIG. 7B are views illustrating X-ray imaging systems of a second embodiment.

### DESCRIPTION OF THE EMBODIMENTS

The present invention aims at providing an X-ray imaging system capable of obtaining a test object image of high sharpness even when a large sized X-ray source is used. Hereinafter, preferable embodiments of the present invention are described in detail on the basis of attached drawings. In each figure, an identical reference number is given to an identical member, and a redundant description is omitted.

An X-ray imaging system related to one embodiment of the present invention uses the same principle as a so-called coded source imaging method (refer to Antonio L. Damato et al., “Coded Source Imaging for Neutrons and X-Rays” 2006 IEEE Nuclear Science Symposium Conference Record, 199-203 (2006)) to suppress the effect of geometric unsharpness.

In general, concerning an image of a test object obtained by X-ray imaging, the effect of geometric unsharpness may be represented mathematically in a form of a convolution of a test object image (hereinafter referred to as an ideal test object image) obtained when an ideal point X-ray source is used with a specific point spread function. Hereinafter, a point spread function is referred to as a PSF. A PSF that represents geometric unsharpness in X-ray imaging is considered to have a distribution substantially similar to an angular distribution of an X-ray that is incident on a micro region on a test object mounting plane and reaches an X-ray detection plane. Therefore, the PSF usually has a distribution similar to an apparent (effective) X-ray source shape when viewed from a test object mounting position. A total spatial expanse of the PSF on the X-ray detection plane varies with a magnification of the imaging system. In the present specification, a shape of an X-ray source means a spatial distribution (an X-ray intensity distribution projected on a plane perpendicular to an optical axis) of emitted X-ray energy intensity.

In the coded source imaging method, a micro X-ray source array (hereinafter may be referred to as a coded X-ray source or a coded source) having a complex shape is used. A test object image that is imaged by using such a coded X-ray source generally becomes a complex image formed of an overlapped plurality of images (an image from which a test object shape is not easily grasped), because a PSF that is an opponent of an ideal test object image in a convolution has a complex shape. A transformation in which an ideal test object image to be obtained in an ideal case is transformed into a complex image by obtaining the test object image by using a coded X-ray source may be referred to as coding of the test object image.

Since a coded image itself is such a complex image formed of an overlapped plurality of images, it is not an image of a high utility value from a viewpoint of visualization of a test object shape in many cases. However, by performing appropriate deconvolution processing on an obtained image, an image closer to an ideal test object image may be retrieved. Sharpness of a test object image retrieved in this way is determined by a spatial expanse of individual micro lobes that constitutes a PSF rather than a total spatial expanse of the PSF. In other words, the sharpness is determined by sizes of a plurality of micro X-ray sources that constitute the coded X-ray source. Therefore, such a test object image may have higher sharpness than is estimated from the total size of the X-ray source. Such retrieval of an image may be referred to as decoding of a test object image.

A coded X-ray source may be obtained, for instance, by disposing an X-ray shield mask having an aperture of a pattern similar to a desired X-ray source shape, near an X-ray source. Such an X-ray shield mask is generally called a coded aperture or a coded aperture mask.

On the other hand, in many X-ray generating devices, since an X-ray source (X-ray generating part) is enclosed by a vacuum tube and is configured to extract an X-ray generated from a planar X-ray generating part from an oblique direction, it is structurally difficult to bring the X-ray source in close contact with a coded aperture mask. Therefore, in this case, a certain distance exists between the X-ray source and the coded aperture mask.

When a distance exists between the X-ray source and the coded aperture mask, there are problems in that an apparent X-ray source shape rapidly changes depending on an in-plane position on a test object mounting surface, or an X-ray irradiated region is limited by an aperture influenced by parallax. In a situation where the apparent X-ray source shape rapidly changes depending on the in-plane position on the test object mounting surface, since a shape of the PSF rapidly changes depending on an in-plane position on the test object mounting surface, decode processing of the test object image may become complicated or accurate image retrieval may become difficult.

In the present embodiment, to avoid the problem, a plurality of X-ray shield masks having an aperture with a periodic pattern is combined instead of using such a coded aperture mask as described above. By partially shielding an X-ray emitted from the X-ray source with the plurality of X-ray shield masks and spatially modulating the shape of the PSF, a coded X-ray source having a desired intensity distribution is formed. Hereinafter, such an X-ray shield mask having an aperture (X-ray transmission part) with a periodic pattern is referred to as a “grating”. Although the number of gratings used for forming a coded X-ray source may be three or more, a configuration example using two gratings is described below. In the present specification, a set of a plurality of gratings used for forming a coded X-ray source is referred to as a micro X-ray source array formation part or a coded source formation part.

Next, in a first embodiment, a general case where the present invention is applied to imaging on the basis of detection of an X-ray transmittance distribution of a test object is described. In a second embodiment, a case where the present invention is applied to imaging by a so-called Talbot-Lau interferometer is described.

### First Embodiment

In a first embodiment of the present invention, a general case where the present invention is applied to imaging on the basis of detection of an X-ray transmittance distribution of a test object is described.

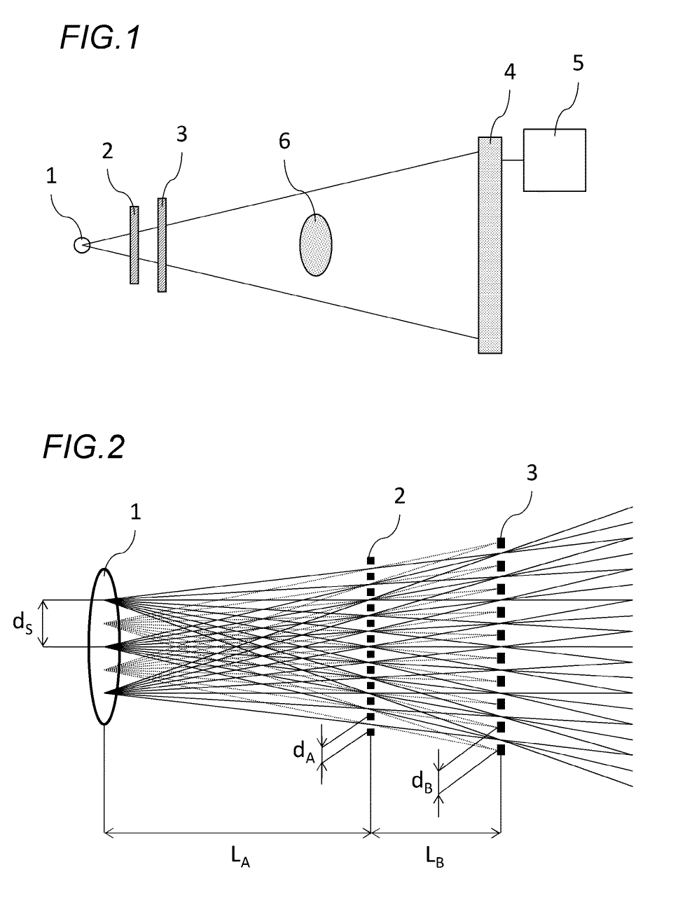

FIG. 1 is a view illustrating a configuration example of an X-ray imaging system of a first embodiment of the present invention. In FIG. 1, the X-ray imaging system includes: an X-ray source 1, a first grating 2, a second grating 3, an X-ray detector 4, and a processing device 5. The first grating 2 and the second grating 3 are disposed between the X-ray source 1 and a test object 6. An X-ray generated from the X-ray source 1 is transmitted through the test object 6 after transmitting the first grating 2 and the second grating 3, and is incident on an X-ray detector 4. The X-ray detector 4 detects an X-ray intensity distribution (or, a test object image) incident on the detection plane, and transmits the detected test object image information to the processing device 5.

The processing device 5 is a computer including a processor, a memory, a storage device, input and output devices, and such. The processing device 5 has a function of controlling each part of the X-ray imaging system in addition to processing and analysis of image information obtained from the X-ray detector 4. The processing and analysis may be achieved by the processor executing a program stored in the memory or the storage device. Part of the function may be substituted by hardware such as a logic circuit. The processing device 5 may be configured by a general purpose computer or may be configured by dedicated hardware such as a board computer or an ASIC.

A shape of a PSF representing geometric unsharpness of a test object image detected by the X-ray detector 4 is modulated by an effect of a combination (superposition) of the first grating 2 and the second grating 3. Accordingly, a detected test object image is coded. An apparent shape (or, an original shape of the X-ray source 1) of the X-ray source 1 in a situation where the first grating 2 and the second grating 3 do not exist is one of factors that influence on a final image quality, but is not necessarily be specifically designed rigorously. It is recommended that cost is reduced by using a general X-ray source 1 of a relatively large light emission spot size and of a uniform intensity distribution (a shape with little undulation). The processing device 5 deconvolutes the obtained test object image and calculates a test object image that is closer to the ideal test object image. By obtaining a shape of a coded X-ray source (a shape of a PSF) formed by the first grating 2 and the second grating 3 in advance, deconvolution corresponding to the PSF may be performed by the processing device 5.

A way in which the first grating 2 and the second grating 3 modulate the PSF is schematically illustrated as in a form of FIG. 2. Here, an effect of X-ray diffraction is ignored as is considered to be sufficiently small. FIG. 2 illustrates a case where both of the first grating 2 and the second grating 3 have a simple periodic structure having an X-ray shielding part and a single aperture (X-ray transmission part) in one period. Below, although a description is made concerning a period in a vertical direction of FIG. 2, in a case of 2-dimensional grating, a similar consideration may be made concerning a period in a depth direction of FIG. 2.

It is preferable that a plurality of gratings that play a role as a coded source formation part are set so that a ratios of grating periods and distances from the X-ray source 1 are equal for all of the gratings. Because, when such a condition is satisfied, the influence of parallax described above may be minimized. Specifically, when a period of the first grating 2, a distance from the X-ray source 1 to the first grating 2, a period of the second grating 3, and a distance from the first grating 2 to the second grating 3 are denoted as d_{A}, L_{A}, d_{B}, L_{B}, respectively, it is preferable that Formula 1 is satisfied.

$$\frac{{d}_{A}}{{L}_{A}} = \frac{{d}_{B}}{{L}_{A} + {L}_{B}} \qquad Formula ( 1 )$$

In a discussion below, it is assumed that d_{A} and d_{B} are significantly smaller than L_{A} and L_{B}.

As illustrated in FIG. 2, there appear, inside the X-ray source 1, an X-ray generating point where a generated X-ray is easily transmitted through apertures of two gratings and an X-ray generating point where a generated X-ray is hardly transmitted through two gratings by being shielded by either of the gratings. For instance, although an X-ray that is transmitted through a trajectory shown by a solid line in FIG. 2 may be transmitted through aperture parts of both of two gratings, an X-ray that is transmitted through a trajectory shown by a dotted line in FIG. 2 may be transmitted through an aperture of the first grating 2 but is shielded by an X-ray shielding part of the subsequent second grating 3. In other words, although a probability that, inside the X-ray source 1 shown in FIG. 2, an X-ray generated from a point where solid lines are converged is transmitted through both of two gratings is relatively high, a probability that an X-ray generated from a point where dotted lines are converged is transmitted through both of two gratings is relatively low. In other words, a ratio of X-rays that may be transmitted through both of the gratings 2 and 3 among X-rays generated from the X-ray source 1 (hereinafter referred to as transmitted X-rays) varies depending on a position of an X-ray generating point on the X-ray source.

By such an effect, a PSF for representing the above-described geometric unsharpness associated with the present imaging system is modulated, and a coded X-ray source is virtually formed. A variation dependent on a position on a test object mounting surface concerning a low frequency component of the PSF modulated in this manner is relatively small.

As can be seen from FIG. 2, such a coded X-ray source has a periodic pattern corresponding to a ratio variation of transmitted X-rays, and a period d_{S} of a spatial modulation of an emitted X-ray intensity distribution may be represented by Formula 2.

$${d}_{s} = \frac{{d}_{B} {L}_{A}}{{L}_{B}} \qquad Formula ( 2 )$$

In other words, a coded X-ray source formed by the gratings 2 and 3 has a pattern in which emitted X-ray intensity varies with a period of d_{B}×L_{A}/L_{B}.

Such formation of the coded X-ray source by a combination of a plurality of gratings 2 and 3 corresponds to an apparent X-ray source shape being modulated by moire generated by superposition of the plurality of gratings 2 and 3 viewed from a certain position on the test object mounting surface in the present embodiment. In other words, the coded X-ray source virtually formed by the plurality of gratings 2 and 3 has a pattern (shape and period) corresponding to moire generated by superposition of the gratings 2 and 3.

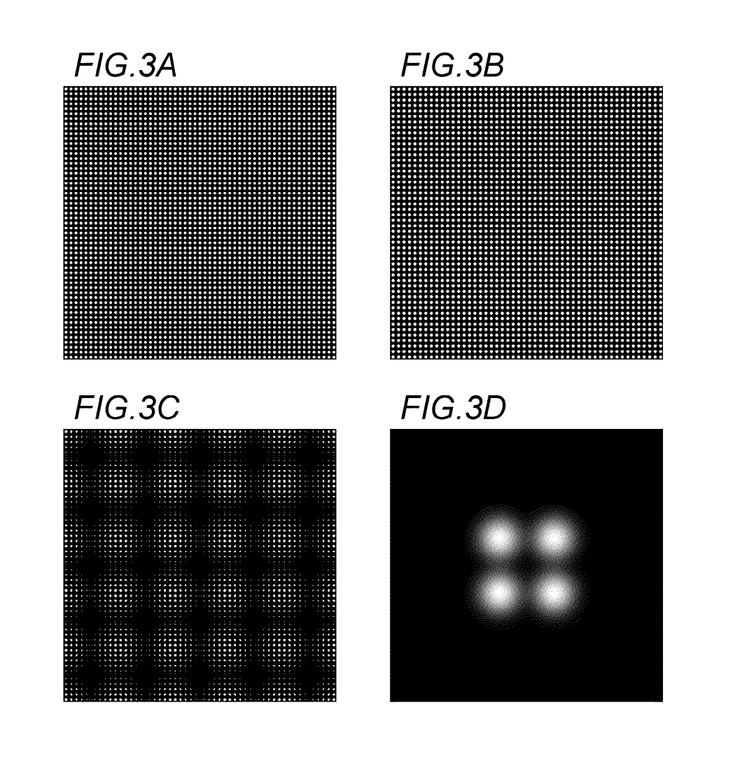

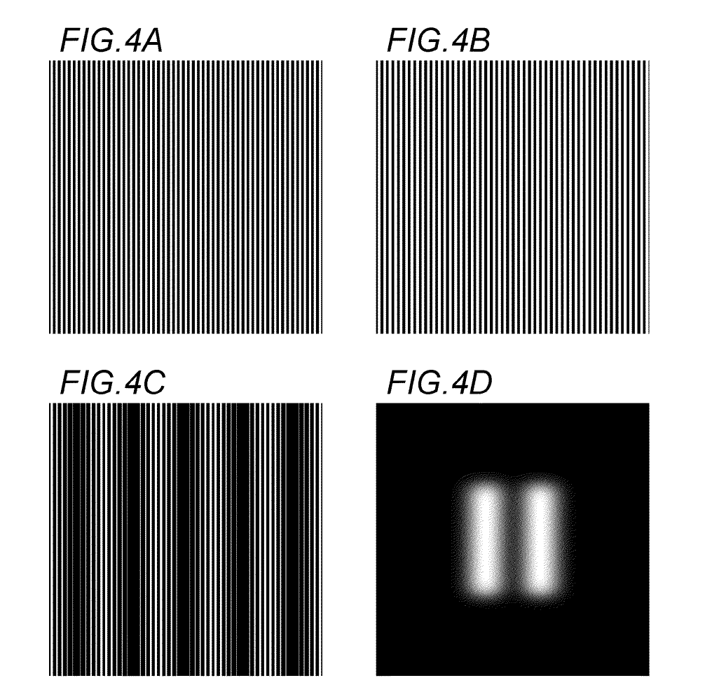

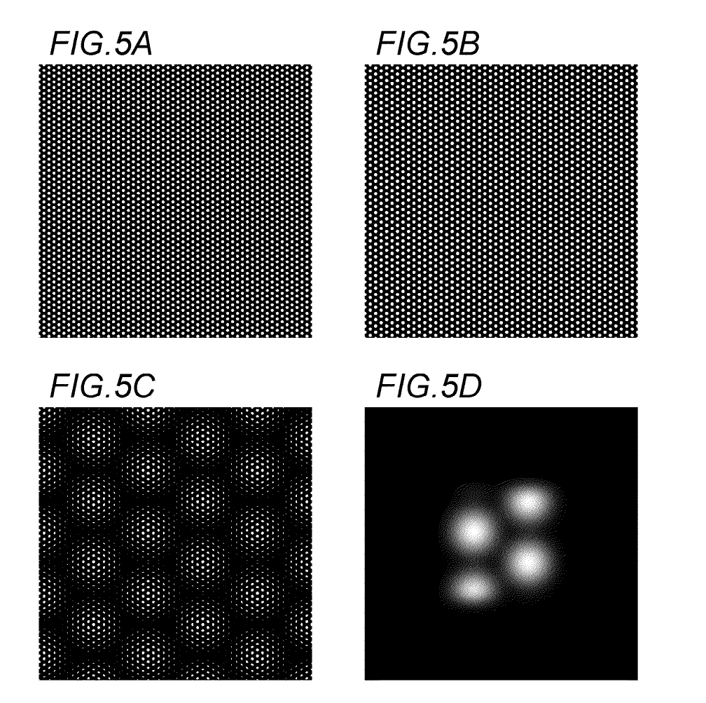

FIG. 3, FIG. 4, and FIG. 5 are examples of each pattern of the first grating 2 and the second grating 3, moire formed by both of the gratings, and PSF shapes (or, a shape of the coded X-ray source) for representing geometric unsharpness of the test object image modulated by an effect of the first grating 2 and the second grating 3. Here, PSF examples after applying image processing for suppressing high frequency components corresponding to an influence of individual apertures of gratings are shown. Sharpness of the test object image in an actual imaging system is determined as a result of a plurality of factors of unsharpness including performance of an X-ray detector 4 acting collectively. For this reason, in many cases, frequency components equal to or higher than a certain frequency in PSFs representing effects of individual factors realistically make little difference. For calculation of a PSF, a case where the X-ray source 1 has an apparent shape close to a square is assumed.

FIG. 3A to FIG. 3D illustrate examples in which the first grating 2 and the second grating 3 have square grating patterns. FIG. 3A illustrates a pattern of the first grating 2, FIG. 3B illustrates a pattern of the second grating 3, and FIG. 3C illustrates a pattern of moire formed by two gratings. FIG. 3D represents a shape of a PSF for representing geometric unsharpness. It is understood that, by being transmitted through two gratings 2 and 3, as illustrated in FIG. 3D, a square shaped original X-ray source is divided into four small X-ray sources by moire, and a virtual coded X-ray source is formed.

FIG. 4A to FIG. 4D illustrate examples in which the first grating 2 and the second grating 3 have one dimensional grating patterns. FIG. 5A to FIG. 5D illustrate examples in which the first grating 2 and the second grating 3 have hexagonal grating patterns. In this manner, by changing patterns of the first grating 2 and the second grating 3, a modulation pattern of a PSF may be changed.

Examples shown in FIG. 3 to FIG. 5 are examples of a case where most basic periodic patterns are adopted for patterns of the first and the second gratings, and do not limit a scope of the present invention. A pattern of a grating is acceptable only if it is periodic, and a pattern in one period is arbitrary. For instance, a ratio of an aperture diameter (or, a width) to a period may be changed, and a shape of the aperture may be changed. Also, it is acceptable to have a plurality of apertures in one period. Furthermore, it is acceptable to have different patterns for a pattern in one period of the first grating 2 and for a pattern in one period of the second grating 3. In this manner, by variously changing patterns in one period of the first grating 2 and the second grating 3, a modulation pattern of a PSF may also be significantly changed.

Deconvolution of the test object image by the processing device 5 may be performed by using generally known various methods of deconvolution processing. In this case, deconvolution is performed by assuming that the coded X-ray source has a period represented by d_{S} of Formula (2). Even when deconvolution without specifying a pattern of the coded X-ray source in advance (blind deconvolution) is performed, as a result, deconvolution is performed by assuming that the coded X-ray source has a period shown by d_{S} of Formula (2).

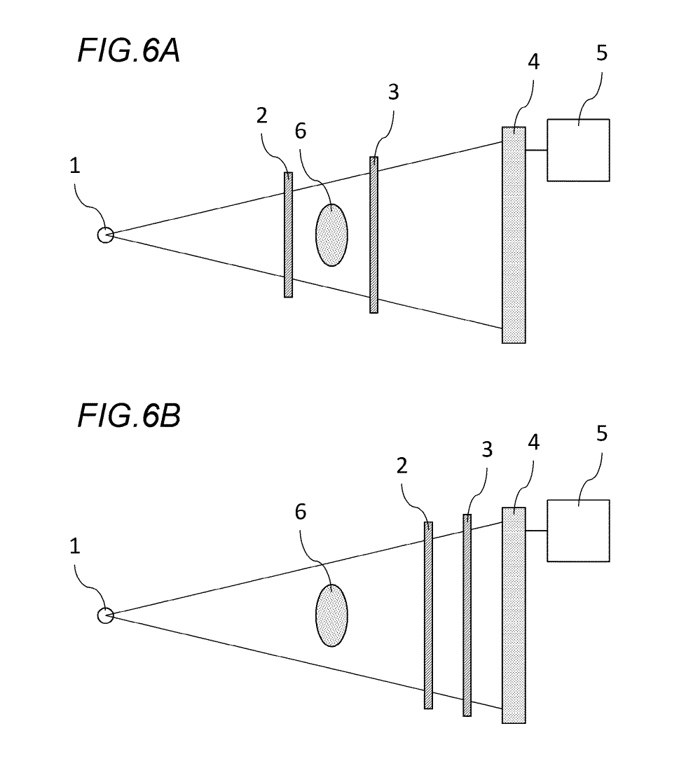

Although, in FIG. 1, an example in which the first grating 2 and the second grating 3 are disposed between the X-ray source 1 and test object 6, a disposition of the gratings 2 and 3 is not limited to this. As illustrated in FIG. 6A, it is acceptable to dispose the first grating 2 between the X-ray source 1 and test object 6, and to dispose the second grating 3 between the test object 6 and the X-ray detector 4. As illustrated in FIG. 6B, it is also acceptable to dispose the first grating 2 and the second grating 3 between the test object 6 and the X-ray detector 4. Even when the number of gratings is increased, a grating may be disposed at an arbitrary position between the X-ray source 1 and the X-ray detector 4. In other words, it is possible to obtain a similar effect when a plurality of gratings are disposed in a middle way of a path through which an X-ray emitted from the X-ray source 1 is transmitted through the test object 6 and is incident on the X-ray detector 4 so as to form moire of a desired pattern.

### Second Embodiment

In a second embodiment of the present invention, a case where the present invention is applied to a so-called Talbot interferometer is described.

The Talbot interferometer is a type of interferometer that uses a G1 grating for diffracting an X-ray that is transmitted through a test object, uses a G2 grating disposed at a position where an interference fringe (called a self-image) of the X-ray that is transmitted through the G1 grating is formed, and observe a moire fringe generated by the interference fringe and the G2 grating. Since the self-image of the G1 grating is deformed according to a deformation of a wavefront of the X-ray that is transmitted through the test object, phase information of the X-ray that is transmitted through the test object is obtained by analyzing an image of moire fringe deformation. When used in a condition where sufficient coherence for obtaining an interference fringe is not obtained because an X-ray source is too large, a method in which, by disposing a G0 grating having slits or micro apertures disposed in a constant period between the X-ray source and the test object, the X-ray source is transformed to a number of periodically arranged linear or punctiform X-ray sources, is adopted. A configuration that uses such a G0 grating is called a Talbot-Lau interferometer (refer to Franz Pfeiffer et al., “Phase retrieval and differential phase-contrast imaging with low-brilliance X-ray sources” Nature Physics, vol. 2, 258-261 (2006)). The G0 grating, the G1 grating, and the G2 grating are also called a source grating, a beam splitter grating, and an analyzer grating, respectively. Also in the Talbot interferometer, a principle of the coded source imaging method may be approximately used.

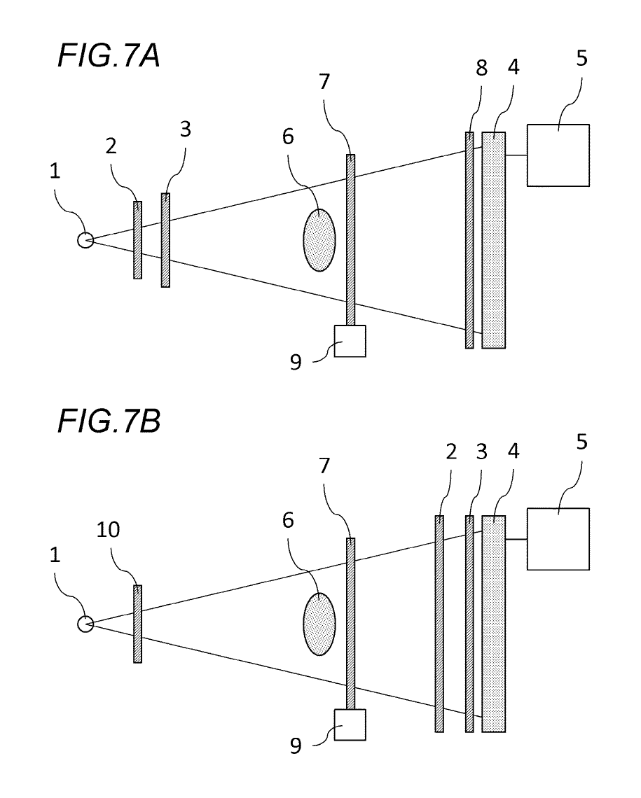

FIG. 7A illustrates a configuration example of an X-ray imaging system of a second embodiment of the present invention. A difference from the first embodiment of the present invention is that a Talbot interferometer is configured by including a beam splitter grating 7 and an analyzer grating 8. Furthermore, the first grating 2 simultaneously plays a role of the source grating of the Talbot interferometer. An actuator as a moving part is connected to a positioning stage 9, and the beam splitter grating 7 may be moved in a plane, thus Talbot interferometry by a phase-shifting method is made possible. The beam splitter grating is a diffraction grating. Although it may be a phase type diffraction grating (phase grating) that periodically modulates phase of an X-ray, or it maybe an amplitude type diffraction grating (shield grating) that periodically modulates amplitude of an X-ray, phase gratings are used in many cases because a loss of an X-ray is small. For an analyzer grating, X-ray shield gratings in which X-ray transmission parts and shielding parts are arranged are used in many cases.

By simultaneously utilizing the first grating 2 as a source grating, the number of required gratings is suppressed as a whole and a device configuration may be simplified, and an advantage of being capable of relatively suppressing reduction in X-ray transmittance of a total system that is constituted of gratings is obtained.

In order to simultaneously utilize the first grating 2 as a source grating, for instance, when adopting a pattern as shown in FIG. 3A as a pattern of the first grating 2, a configuration may be such that a period d_{A} of the first grating 2 satisfies Formula (3).

$${d}_{A} = \frac{{d}_{I} {L}_{1}}{{L}_{2}} \qquad Formula ( 3 )$$

Here, d_{I}, L₁, and L₂ represents a period of an X-ray interference fringe formed on the analyzer grating 8, a distance between the first grating 2 and the beam splitter grating 7, and a distance between the beam splitter grating 7 and the analyzer grating 8, respectively. A formed interference fringe pattern is assumed here to be a square grating (mesh) pattern. Also in the present embodiment, similar to the embodiment 1, an apparent X-ray source shape is modulated by moire generated by superposition of the first grating 2 and the second grating 3. Therefore, when patterns such as FIG. 3A and FIG. 3B are adopted as patterns of the first grating 2 and the second grating 3, a moire pattern such as FIG. 3C is formed by superposition of two gratings. In the moire pattern in FIG. 3C, a plurality of small aperture parts are formed in about 5 by 5 circular aperture parts arranged horizontally and vertically. In other words, the moire of FIG. 3C is moire in which larger dot patterns are formed by a set of small aperture parts. When this circular aperture part is a single circular aperture part, coherence sufficient for obtaining an interference fringe is not obtained because of the aperture part being too large. However, in the present embodiment, the first grating has such a pitch to satisfy Formula (3). Thus, since each one of circular aperture parts that constitute the coded X-ray source is composed of further micro X-ray sources (small aperture parts in the circular aperture part), coherence sufficient for obtaining an interference fringe may be obtained.

An aperture pattern for simultaneously utilizing the first grating 2 as a source grating may not necessarily be a pattern like FIG. 3A. A configuration that satisfies Formula (3) is only one example of a typical case. Even when Formula (3) is not satisfied, details may be freely determined as far as the first grating 2 is such a combination of aperture patterns, periods, and dispositions to substantially function as a source grating.

The processing device 5, similar to the first embodiment, deconvolutes an obtained test object image and calculates a test object image that is closer to an ideal test object image. Then, by analyzing a plurality of test object images obtained with changing a position of the beam splitter grating 7 on the basis of a phase-shifting method, the processing device 5 may calculate a differential phase distribution of an X-ray that is transmitted through a test object and such. Since a method of utilizing the phase-shifting method in the X-ray Talbot interferometer is described in detail in U.S. Pat. No. 7,180,979, etc., a description is omitted here.

However, there are cases where, when a period of moire generated between an X-ray interference fringe and the analyzer grating 8 is relatively short, obtaining an image close to an ideal test object image by directly deconvoluting an X-ray intensity distribution obtained by the X-ray detector 4 becomes difficult. In such a case, the processing device 5 may first perform phase retrieval (analysis based on the phase-shifting method in a case of the present embodiment where the phase-shifting method is performed) on the basis of a plurality of obtained test object images, calculate temporary test object information (for instance, a differential phase distribution of an X-ray that is transmitted through a test object, and such), and then deconvolute the obtained temporary test object information. The test object information indicates information based on a phase change of an X-ray by a test object (differential phase distribution, and such), information based on an intensity variation of an X-ray by a test object (transmittance distribution), information based on small-angle scattering of an X-ray by a test object (scattering distribution), and such.

Although in the present embodiment, when a plurality of gratings for forming a coded X-ray source are applied to a Talbot-Lau interferometer, one of the gratings (a first grating 2) also serves as a source grating, a configuration of the present invention is not limited to this. For instance, the second grating 3 may also serve a role of a source grating. Also, as shown in FIG. 7B, by disposing the first grating 2 and the second grating 3 between the beam splitter grating 7 and X-ray detector 4, a configuration may be such that either one of the first grating 2 and the second grating 3 also serves a role of the analyzer grating. A reference number 10 of FIG. 7B represents the source grating. Or, simply a plurality of gratings for forming a coded X-ray source may be added in addition to the source grating and the analyzer grating. In that case, although there is a disadvantage that the number of gratings in the entire system increases, there is an advantage that a degree of freedom in design is raised because a grating may be disposed at an arbitrary position between the X-ray source 1 and the X-ray detector 4.

Below, more specific example of each embodiment is described.

### EXAMPLE 1

Example 1 is a specific example of a first embodiment. An X-ray source 1 is an X-ray generating part on an anode of a rotating anode X-ray tube. An anode material is molybdenum, and is used under a tube voltage of 30 kV. An apparent shape of the X-ray source 1 is a shape close to a square having a side length of 600 μm. The first grating 2 and the second grating 3 are both gold gratings of 100 μm in thickness, and have square grating shaped aperture patterns as illustrated in FIG. 3A and FIG. 3B. A period d_{A} of an aperture of the first grating 2 is 10.000 μm, an aperture shape is a circle of 5.642 μm in diameter. On the other hand, a period d_{B} of an aperture of the second grating 3 is 10.345 μm, an aperture shape is a circle of 5.837 μm in diameter. The X-ray detector 4 is a flat panel detector, a pixel size is 50 μm.

A disposition of each constituent is similar to FIG. 1. A distance L_{A} between the X-ray source 1 and the first grating 2 is 150.00 mm. A distance L_{B} between the first grating 2 and the second grating 3 is 5.17 mm. A distance L_{S} between the X-ray source 1 and a mounting surface of a test object 6 is 1 m. A distance L_{D} between the mounting surface of the test object 6 and the X-ray detector 4 is 1 m.

In this case, a modulation period d_{S} of an X-ray source by an effect of the first grating 2 and the second grating 3 is calculated as about 300 μm from Formula (2). Since L_{S}=L_{D}, a PSF for representing geometric unsharpness of the present imaging system has a shape close to a shape in which a square having a side length of 600 μm is modulated by a period of about 300 μm, which is similar to FIG. 3D.

The processing device 5 retrieves an image close to an ideal test object image by deconvoluting coded test object image data obtained by the X-ray detector 4.

### EXAMPLE 2

Example 2 is a specific example of a second embodiment. The X-ray source 1 is similar to Example 1. The first grating 2 and the second grating 3 are gold gratings of 100 μm in thickness, and have square grating shaped aperture patterns as illustrated in FIG. 3A and FIG. 3B. A period d_{A} of an aperture of the first grating 2 is 16.000 μm, an aperture shape is a circle of 9.027 μm in diameter. On the other hand, a period d_{B} of an aperture of the second grating 3 is 16.901 μm, and an aperture shape is a circle of 9.535 μm in diameter. The X-ray detector 4 is a flat panel detector, and a pixel size is 50 μm.

A design of a Talbot interferometer is optimized for an X-ray of 17.5 keV in photon energy in accordance with a characteristic X-ray of molybdenum. The beam splitter grating 7 and the analyzer grating 8 have patterns of one dimensional grating. The beam splitter grating 7 is a silicon made phase type diffraction grating, and is capable of providing a phase modulation of π rad for a transmitted X-ray of 17.5 keV in photon energy by having a pattern in which phase advance parts of 8.000 μm in width and phase delay parts of 8.000 μm in width, are alternately arranged. The analyzer grating 8 is a gold grating of 100 μm in thickness, and a slit shaped aperture of 8.000 μm in width is formed at a period of 16.000 μm.

A disposition of each constituent is similar to FIG. 7A. A distance L_{A} between the X-ray source 1 and the first grating 2 is 150.00 mm, and distance L_{B} between the first grating 2 and the second grating 3 is 8.45 mm. A distance L₁ between the first grating 2 and the beam splitter grating 7 is 903.34 mm, and a distance L₂ between the beam splitter grating 7 and the analyzer grating 8 is 903.34 mm. A distance L_{S} between the X-ray source 1 and the mounting surface of the test object 6 is 1 m, and a distance L_{D} between the mounting surface of the test object 6 and the X-ray detector 4 is 1 m.

In this case, a modulation period d_{S} by an effect of the first grating 2 and the second grating 3 is calculated as about 300 μm from Formula (2). Furthermore, since L_{S}=L_{D}, a PSF for representing geometric unsharpness of the present imaging system has a shape close to a shape in which a square having a side length of 600 μm is modulated by a period of about 300 μm, which is similar to FIG. 3D.

The X-ray detector 4 detects a moire image generated between an interference pattern formed by the beam splitter grating 7 and the analyzer grating 8 as a test object image. In the present example, a test object image is detected in a state where an adjustment is performed so that a moire period becomes sufficiently large. Subsequently, the processing device 5 retrieves an image close to an ideal test object image by deconvoluting coded test object image data obtained by the X-ray detector 4.

The processing device 5 performs analysis based on a phase-shifting method on the basis of a plurality of images obtained by deconvoluting a plurality of test object images detected with changing a position of the beam splitter grating 7. Finally, the processing device 5 outputs a differential phase distribution of an X-ray transmitted a test object as a result of the analysis.

Although the preferable embodiments of the present invention are described above, the present invention is not limited to these embodiments, various modifications are possible within a scope of the summary. In the present invention and the present specification, imaging is not limited to obtaining images based on information of a test object, and detecting intensity of an X-ray irradiated on the test object at a plurality of positions as a whole is referred to as imaging of the test object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-186216, filed on Sep. 9, 2013, which is hereby incorporated by reference herein in its entirety.

What is claimed is:

1. An X-ray imaging system comprising:
a micro X-ray source array formation part configured to form a micro X-ray source array by partially shielding an X-ray emitted from an X-ray source; and
an X-ray detector configured to detect an X-ray transmitted through a test object,
wherein the micro X-ray source array formation part includes a plurality of gratings disposed between the X-ray source and the X-ray detector, a ratio of X-rays transmitted through all of the plurality of gratings to X-rays generated from the X-ray source varies depending on a position of an X-ray generating point on the X-ray source, and the micro X-ray source array formation part forms a micro X-ray source array of a pattern in accordance with the variation of the ratio of the transmitted X-rays.

2. The X-ray imaging system according to claim 1, wherein the micro X-ray source array formation part is configured such that the ratio of the transmitted X-rays periodically varies depending on a position of an X-ray generating point on the X-ray source, and is configured to form a micro X-ray source array of a pattern corresponding to the periodical variation of the ratio of the transmitted X-rays.

3. An X-ray imaging system comprising:
a micro X-ray source array formation part configured to form a micro X-ray source array by partially shielding an X-ray emitted from an X-ray source; and
an X-ray detector configured to detect an X-ray transmitted through a test object,
wherein the micro X-ray source array formation part includes a plurality of gratings disposed between the X-ray source and the X-ray detector, and is configured to form a micro X-ray source array of a pattern corresponding to moire generated by superposition of the plurality of gratings.

4. The X-ray imaging system according to claim 1, wherein the plurality of gratings includes a first grating, and a second grating disposed between the first grating and the X-ray detector, and
d_{A}/L_{A}=d_{B}/(L_{A}+L_{B}) is satisfied, where a period of the first grating, a distance from the X-ray source to the first grating, a period of the second grating, and a distance from the first grating to the second grating are denoted as d_{A}, L_{A}, d_{B}, and L_{B}, respectively.

5. The X-ray imaging system according to claim 3, wherein the plurality of gratings includes a first grating, and a second grating disposed between the first grating and the X-ray detector, and
d_{A}/L_{A}=d_{B}/(L_{A}+L_{B}) is satisfied, where a period of the first grating, a distance from the X-ray source to the first grating, a period of the second grating, and a distance from the first grating to the second grating are denoted as d_{A}, L_{A}, d_{B}, and L_{B}, respectively.

6. The X-ray imaging system according to claim 4, wherein the micro X-ray source array includes a pattern in which intensity of an emitted X-ray varies at a period of d_{B}×L_{A}/L_{B}.

7. The X-ray imaging system according to claim 5, wherein the micro X-ray source array includes a pattern in which intensity of an emitted X-ray varies at a period of d_{B}×L_{A}/L_{B}.

8. The X-ray imaging system according to claim 4, wherein a size of the X-ray source is larger than d_{B}×L_{A}/L_{B}.

9. The X-ray imaging system according to claim 5, wherein a size of the X-ray source is larger than d_{B}×L_{A}/L_{B}.

10. The X-ray imaging system according to claim 1, wherein the plurality of gratings are disposed between the X-ray source and the test object.

11. The X-ray imaging system according to claim 1, wherein the plurality of gratings include a grating disposed between the X-ray source and the test object, and a grating disposed between the test object and the X-ray detector.

12. The X-ray imaging system according to claim 1, wherein the plurality of gratings are disposed between the test object and the X-ray detector.

13. The X-ray imaging system according to claim 1, wherein the X-ray imaging system is a Talbot-Lau interferometer, and
any one of the plurality of gratings also serves as a source grating.

14. The X-ray imaging system according to claim 3, wherein the X-ray imaging system is a Talbot-Lau interferometer, and
any one of the plurality of gratings also serves as a source grating.

15. The X-ray imaging system according to claim 1, wherein the X-ray imaging system is a Talbot-Lau interferometer, and
any one of the plurality of gratings also serves as an analyzer grating.

16. The X-ray imaging system according to claim 3, wherein the X-ray imaging system is a Talbot-Lau interferometer, and
any one of the plurality of gratings also serves as an analyzer grating.

17. The X-ray imaging system according to claim 1, further comprising a processing device configured to perform deconvolution of intensity distribution information of an X-ray detected by the X-ray detector on the basis of a shape of the micro X-ray source array.

18. The X-ray imaging system according to claim 3, further comprising a processing device configured to perform deconvolution of intensity distribution information of an X-ray detected by the X-ray detector on the basis of a shape of the micro X-ray source array.

19. The X-ray imaging system according to claim 17, wherein the processing device is configured to obtain information of the test object by performing the deconvolution after obtaining temporary information of the test object by using the intensity distribution information of the X-ray.
